(19) United States
(12) Patent Application Publication
(10) Pub. No.: US 2008/0042941 A1
(43) Pub. Date: Feb. 21, 2008

(54) System for displaying image and driving method for organic light-emitting element

(75) Inventors: Du-Zen Peng, Taipei (TW); Shih-Chang Chang, Taipei (TW)

Correspondence Address: BIRCH STEWART KOLASCH & BIRCH, PO BOX 747, FALLS CHURCH, VA, 22040-0747, US

(73) Assignee: TPO DISPLAYS CORP.

(21) Appl. No.: 11/889,553

(22) Filed: Aug. 14, 2007

(30) Foreign Application Priority Data
Aug. 16, 2006 (TW) 095130165

(51) Int. Cl. G09G 3/30

(52) U.S. Cl. 345/76

(57) ABSTRACT

A system for displaying an image includes a plurality of pixel structures. Each pixel structure includes an organic light-emitting element and a pixel driving circuit, which drives the organic light-emitting element and is electrically connected with a first scan line and a data line. The pixel driving circuit includes a drive element, a storage capacitor, a select switch and a data switch. The drive element outputs a current to the organic light-emitting element. The storage capacitor has a first terminal and a second terminal respectively electrically connected with two terminals of the drive element to control the current outputted from the drive element. The select switch is electrically connected with the first scan line to connect/disconnect the data line and the first terminal of the storage capacitor. The data switch is electrically connected with the first scan line to connect/disconnect a second scan line and the second terminal of the storage capacitor.

### CROSS REFERENCE TO RELATED APPLICATIONS

This Non-provisional application claims priority under 35 U.S.C. §119(a) on Patent Application No(s). 095130165 filed in Taiwan, Republic of China on Aug. 16, 2006, the entire contents of which are hereby incorporated by reference.

### BACKGROUND OF THE INVENTION

1. Field of Invention

The invention relates to a system and a driving method for a light-emitting element, and, in particular, to a system for displaying an image and a driving method for an organic light-emitting element.

2. Related Art

Organic light-emitting displays (OLEDs) may be classified into passive-matrix organic light-emitting displays (PM-OLED) and active-matrix organic light-emitting displays (AM-OLED) according to the driving method thereof. However, the PM-OLED has a shorter lifetime and cannot be made with a large area due to restrictions of the driving mode. So, the AM-OLED is more suitable for the high-resolution and large-size applications.

The AM-OLED mainly includes an organic light-emitting element electrically connected with a pixel driving circuit. The pixel driving circuit is electrically connected with a scan driving circuit and a data driving circuit. The pixel driving circuit is controlled by the scan driving circuit to receive the data written into the data driving circuit so as to drive the organic light-emitting element to display the frame data.

FIGS. 1 and 2 are equivalent circuit diagrams showing pixel driving circuits in a conventional AM-OLED. As shown in FIG. 1, a pixel driving circuit 1 includes a select switch 11, a drive element 12 and a storage capacitor 13. The pixel driving circuit 1 drives an organic light-emitting element 14. The select switch 11 and the drive element 12 are N-type thin film transistors. The select switch 11 has a gate electrically connected with a scan line (SL) to receive a scan signal from a scan driving circuit, a drain electrically connected with a data line (DL) to receive a data signal from a data driving circuit, and a source electrically connected with the storage capacitor 13 and a gate of the drive element 12. Two terminals of the storage capacitor 13 are respectively electrically connected with the gate and a source of the drive element 12. The storage capacitor 13 controls a current outputted from the drive element 12. The organic light-emitting element 14 is electrically connected with and between a power source V_{DD} and a drain of the drive element 12. The current outputted from the drive element 12 drives the organic light-emitting element 14 to emit light.

The enabled scan signal turns on a path from the drain to the source of the select switch 11 so that the data signal is written into the storage capacitor 13. The storage capacitor 13 records a voltage of the data signal for controlling the current outputted from the drive element 12. However, under this driving architecture, the organic light-emitting element 14 is a reverse structure, which is the reverse of the structure of the organic light-emitting element 14, and is not compatible with the present manufacturing process. In addition, the cathodes of the organic light-emitting elements 14 of the pixel driving circuits 1 may not be coupled with each other suitably. Thus, this pixel driving circuit 1 is seldom used.

As shown in FIG. 2, the pixel driving circuit 1′ of FIG. 2 is different from that of FIG. 1 in that the two terminals of the storage capacitor 13 are respectively electrically connected with the gate and the drain of the drive element 12′, and the organic light-emitting element 14 is electrically connected with and between a power source V_{SS} and the source of the drive element 12′, wherein the power source V_{SS} may have a ground voltage. However, the current generated by the drive element 12′ is influenced by the loading voltage of the organic light-emitting element 14 under this driving architecture. When the loading voltage increases, the driving current decreases. If the attenuated organic light-emitting element 14 is driven by the same current, the loading voltage on the organic light-emitting element 14 increases, thereby decreasing the current generated by the drive element 12′. Thus, the luminance of the organic light-emitting element 14 is influenced.

In addition, the data driving circuit has to increase the voltage of the data signal to mitigate the problem of the loading voltage in order to control the current generated by the drive element 12′ precisely. However, the required high-voltage IC driver is usually made by a more expensive semiconductor manufacturing process, thus increasing the cost of the OLED. Furthermore, the lifetime of the organic light-emitting element 14 is shortened if the organic light-emitting element 14 is driven according to the conventional method.

Therefore, it is an important subject to provide a system for displaying an image and a driving method for an organic light-emitting element, which can solve the above mentioned problems.

### SUMMARY OF THE INVENTION

In view of the foregoing, the invention is to provide a system for displaying an image and a driving method for an organic light-emitting element, wherein the lifetime of the organic light-emitting element can be extended.

In view of the foregoing, the invention is to provide a system for displaying an image and a driving method for an organic light-emitting element, wherein the lifetime of the organic light-emitting element can be extended.

To achieve the above, the invention discloses a driving method, which is used in a pixel driving circuit. The pixel driving circuit is electrically connected with a first scan line and a data line and is for driving an organic light-emitting element. The pixel driving circuit includes a drive element and a storage capacitor. The driving method includes the following steps. First, a data signal is controlled to be written into the storage capacitor from the data line when a signal on the first scan line is enabled, so as to set a voltage at a first terminal of the storage capacitor. Next, a second scan line is controlled to set a voltage at a second terminal of the storage capacitor when the signal on the first scan line is enabled. Finally, the drive element is controlled to output a current to the organic light-emitting element according to a voltage difference between the first terminal and the second terminal of the storage capacitor to drive the organic light-emitting element to emit light.

As mentioned above, the output current of the drive element is controlled according to the voltage difference between the first terminal and the second terminal of the storage capacitor. The first terminal of the storage capacitor is connected with the data line and receives the data signal and the second terminal of the storage capacitor is connected to the second scan line and receives another scan signal when the first scan signal is enabled. Thus, the loading voltage of the organic light-emitting element does not influence the current outputted from the drive element, and the terminal voltage of the organic light-emitting element connected with the drive element is controlled so that the lifetime of the organic light-emitting element can be extended.

### BRIEF DESCRIPTION OF THE DRAWINGS

The invention will become more fully understood from the detailed description given herein below illustration only, and thus is not limitative of the present invention, and wherein:

FIGS. 1 and 2 are equivalent circuit diagrams showing pixel driving circuits in a conventional organic light-emitting display;

FIG. 3 is an equivalent circuit diagram showing a pixel driving circuit according to an embodiment of the invention;

FIG. 4 shows waveforms of scan signals on scan lines in the pixel driving circuit according to the embodiment of the invention;

FIG. 5 is another equivalent circuit diagram showing the pixel driving circuit according to the embodiment of the invention;

FIG. 6 is a schematic illustration showing a system for displaying an image according to the embodiment of the invention; and

FIG. 7 is a flow chart showing a driving method of the pixel driving circuit according to the embodiment of the invention.

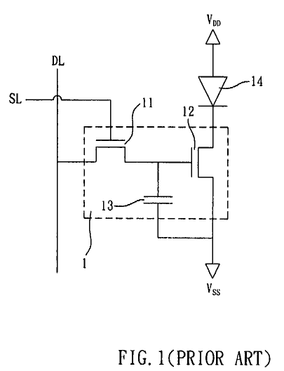

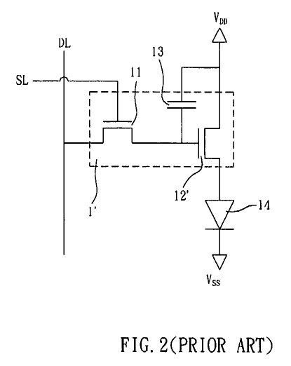

### DETAILED DESCRIPTION OF THE INVENTION

The present invention will be apparent from the following detailed description, which proceeds with reference to the accompanying drawings, wherein the same references relate to the same elements.

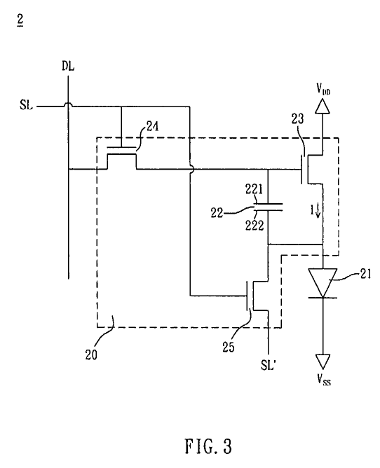

FIG. 3 is an equivalent circuit diagram showing a pixel driving circuit according to an embodiment of the invention. Referring to FIG. 3, a system for displaying an image includes a plurality of pixel structures 2 each including an organic light-emitting element 21 and a pixel driving circuit 20. The pixel driving circuit 20 drives the organic light-emitting element 21, is electrically connected with a first scan line SL and a data line DL, and includes a storage capacitor 22, a drive element 23, a select switch 24 and a data switch 25. The drive element 23 electrically connected with a power source V_{DD} and outputs a current 1 to the organic light-emitting element 21 to drive the organic light-emitting element 21 to emit light. The organic light-emitting element 21 is electrically connected with and between the drive element 23 and a power source V_{SS}, and has a lighting intensity controlled by the current 1, wherein the power source V_{SS} may have a ground voltage. The storage capacitor 22 has a first terminal 221 and a second terminal 222, which are respectively electrically connected with two terminals of the drive element 23 to control the current 1 outputted from the drive element 23. One terminal of the drive element 23 is connected to a second scan line SL′. The select switch 24 is electrically connected with the first scan line SL to electrically connect/disconnect the data line DL and the first terminal 221 of the storage capacitor 22. The data switch 25 is electrically connected with the first scan line SL to connect/disconnect the second scan line SL′ and the second terminal 222 of the storage capacitor 22.

In general, the system for displaying an image includes the pixel structures 2, a scan driving circuit and a data driving circuit. The pixel structures 2 are arranged in an array. The plurality of scan lines SL connects the scan driving circuit with the pixel driving circuit 20. The plurality of data lines DL connects the data driving circuit with the pixel driving circuit 20. The data driving circuit operates in conjunction with the scan driving circuit. The scan driving circuit sequentially outputs the scan signals to the scan lines at different time instants and the data driving circuit writes the data into the pixel driving circuit 20 on each scan line through the data lines.

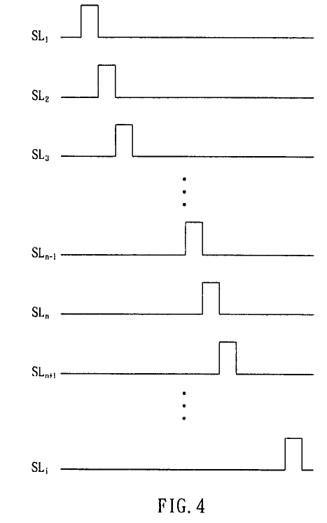

FIG. 4 shows waveforms of scan signals on scan lines SL in the pixel driving circuit 20 according to the embodiment of the invention. As shown in FIG. 4, the scan signals on the scan lines SL₁ to SLᵢ are sequentially enabled according to the order of the scan lines SL, and the scan signals on different scan lines SL are not enabled simultaneously. On the other hand, when the scan signal on each scan line SL is disabled, the voltages thereof and the power source V_{SS} are equal to 0V. Thus, when the scan signal on one of the scan lines SL is enabled, the scan signal on the previous one, the next one or any other scan line SL is disabled, and the voltage on the any other scan line is the same as that of the power source V_{SS}.

As shown in FIG. 3, when the data is being written, the scan signal on the first scan line SL is enabled to turn on the select switch 24 and the data switch 25 so that the select switch 24 turns on a path from the data line DL to the first terminal 221 of the storage capacitor 22, and the data switch 25 turns on a path from the second scan line SL′ to the second terminal 222 of the storage capacitor 22. Because the scan signal on the second scan line SL′ is disabled, the voltage thereof and the power source V_{SS} are equal to 0V so that the voltage difference between the two terminals of the storage capacitor 22 is equal to the voltage of the data line DL, and the data signal is completely written into the storage capacitor 22.

When the data writing operation is to be ended, the scan signal on the first scan line SL is disabled to turn off the select switch 24 and the data switch 25 so that the drive element 23 is disconnected from the data line DL and the second scan line SL′. Thus, the drive element 23 is only controlled by the storage capacitor 22 to output the current 1, which is controlled by the voltage difference between the first terminal 221 and the second terminal 222 of the storage capacitor 22. Because the data signal is precisely recorded in the storage capacitor 22, the current 1 can respond precisely with the data signal to drive the organic light-emitting element 21 to precisely achieve the predetermined lighting intensity.

When the data is being written, the two terminals of the drive element 23 are controlled by the data line DL and the second scan line SL′. So, the loading voltage of the organic light-emitting element 21 does not influence the voltage difference between the two terminals of the drive element 23 and the output current 1 thereof. Thus, the rise of the loading voltage caused by the attenuated organic light-emitting element 21 also does not influence the current 1. Furthermore, because the data line DL charges/discharges the storage capacitor 22 when it is writing the data, the voltage at the second terminal 222 of the storage capacitor 22 approaches 0. So, the writing voltage of the data line DL may be below 5V, and the operation voltage of the data driving circuit may be 5V. The data driving circuit may be implemented in an integrated circuit formed using the typical manufacturing processes such as the CMOS manufacturing processes, and does not have to be manufactured using a special, expensive semiconductor manufacturing processes, such as certain high-voltage processes, so the cost of the data driving circuit can be reduced.

In this embodiment, the second scan line SL′ may be a previousor a next scan line adjacent to the first scan line SL, or any other scan line, as long as the scan signal on the second scan line SL′ is disabled when the scan signal on the first scan line SL is enabled.

In addition, the select switch 24 and the data switch 25 can be N-type transistors, which can be thin film transistors. The select switch 24 can have a gate electrically connected with the first scan line SL, a drain electrically connected with the data line DL, and a source electrically connected with the first terminal 221 of the storage capacitor 22. The data switch 25 can have a gate electrically connected with the first scan line SL, a drain electrically connected with the second terminal 222 of the storage capacitor 22, and a source electrically connected with the second scan line SL′.

The drive element 23 can be an N-type transistor having a gate electrically connected with the first terminal 221 of the storage capacitor 22, a source electrically connected with the second terminal 222 of the storage capacitor 22, and a drain electrically connected with a power source V_{DD}. The current 1 outputted from the drive element 23 is controlled by the voltage difference between the two terminals of the storage capacitor 22. When the voltage difference between the first terminal 221 and the second terminal 222 of the storage capacitor 22 increases, the current 1 outputted from the drive element 23 increases such that the lighting intensity of the organic light-emitting element 21 increases. Because the data signal is precisely recorded in the storage capacitor 22, the current 1 can precisely respond with the data signal so as to drive the organic light-emitting element 21 to reach the predetermined lighting intensity precisely.

In addition, each organic light-emitting element 21 may be commonly connected with the power source V_{SS}, and the organic light-emitting element 21 does not have the reverse structure but rather the same structure as that of the typical organic light-emitting element. So, the organic light-emitting element 21 is compatible with present manufacturing processes.

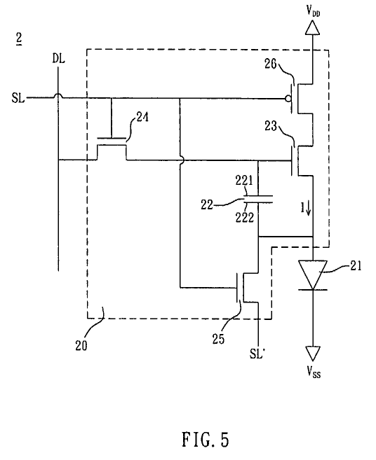

FIG. 5 is another equivalent circuit diagram showing the pixel driving circuit according to the embodiment of the invention. Referring to FIG. 5, the pixel driving circuit 20 further includes a power switch 26, which is electrically connected with the first scan line SL to connect/disconnect the power source V_{DD} and the drive element 23. When the data is being written, in order to prevent the power source V_{DD} from charging the second terminal 222 of the storage capacitor 22 through the drive element 23 so that the voltage at the second terminal 222 of the storage capacitor 22 is equal to the voltage of the second scan line SL′, which is 0V, the power switch 26 isolates the power source V_{DD} from the drive element 23 when the data is being written, and turns on the path from the power source V_{DD} to the drive element 23 after the data is written.

In this embodiment, the power switch 26 is a P-type transistor having a gate electrically connected with the first scan line SL, a source electrically connected with the power source V_{DD}, and a drain electrically connected with the drive element 23. It is to be specified that the transistor of the power switch 26 is complementary to other transistors in the pixel driving circuit 20. If the other transistors, such as the drive element 23, the select switch 24 and the data switch 25, are P-type transistors, the power switch 26 can be an N-type transistor.

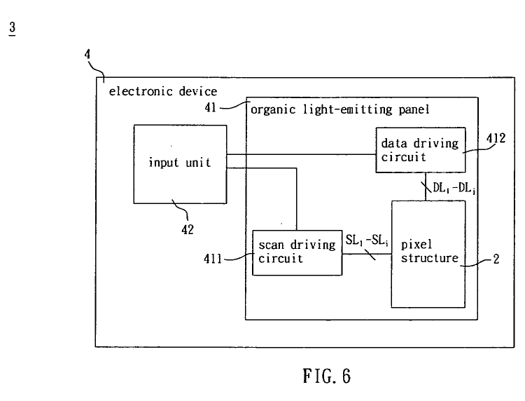

FIG. 6 is a schematic illustration showing a system for displaying an image according to the embodiment of the invention. Referring to FIG. 6, a system 3 for displaying image includes an electronic device 4, which has an organic light-emitting panel 41 and an input unit 42. The organic light-emitting panel 41 includes a pixel structure 2, a scan driving circuit 411 and a data driving circuit 412. The pixel structures 2 are arranged in an array on the organic light-emitting panel 41. On the organic light-emitting panel 41, a plurality of scan lines SL₁ to SLᵢ are electrically connected with and between the scan driving circuit 411 and the pixel driving circuits 20, and a plurality of data lines DL₁ to DLⱼ are electrically connected with and between the data driving circuit 412 and the pixel driving circuits 20. The scan driving circuit 411, the data driving circuit 412, the pixel structure 2 and the pixel driving circuit 20 have been mentioned hereinabove, and detailed descriptions thereof will be omitted. The input unit 42 coupled with the organic light-emitting panel 41 provides an input to the organic light-emitting panel 41 to drive the organic light-emitting panel 41 to display the image. The electronic device 4 may be a mobile phone, a digital camera, a personal digital assistant, a notebook computer, a desktop computer, a television, a vehicle display or a portable DVD drive.

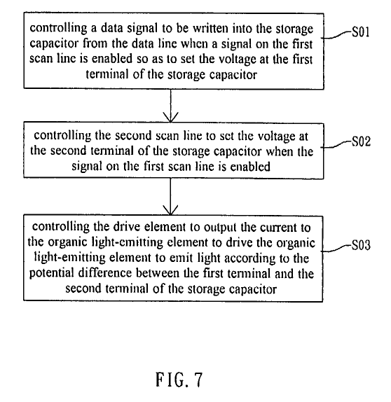

FIG. 7 is a flow chart showing a driving method of the pixel driving circuit according to the embodiment of the invention. Referring to FIG. 7, the driving method for the pixel driving circuit includes steps S01 to S03. The driving method is used in the pixel driving circuit 20. The driving circuit 20 drives the organic light-emitting element 21, is electrically connected with the first scan line SL and the data line DL and includes the drive element 23 and the storage capacitor 22.

Step S01 controls a data signal to be written into the storage capacitor 22 from the data line DL when a signal on the first scan line SL is enabled so as to set the voltage at the first terminal 221 of the storage capacitor 22. Next, step S02 controls the second scan line SL′ to set the voltage at the second terminal 222 of the storage capacitor 22 when the signal on the first scan line SL is enabled. Finally, step S03 controls the drive element 23 to output the current 1 to the organic light-emitting element 21 to drive the organic light-emitting element 21 to emit light according to the voltage difference between the first terminal 221 and the second terminal 222 of the storage capacitor 22.

The driving method for the pixel driving circuit of this embodiment may be applied to the pixel driving circuit 20 according to the embodiment of FIGS. 3 and 5, the same elements have the same functions and effects, and detailed aspects have been described hereinabove, so detailed descriptions thereof will be omitted.

In summary, the output current of the drive element is controlled according to the voltage difference between the first terminal and the second terminal of the storage capacitor. The first terminal of the storage capacitor is connected with the data line and receives the data signal and the second terminal of the storage capacitor is connected to the second scan line and receives another scan signal when the first scan signal is enabled. Thus, the loading voltage of the organic light-emitting element does not influence the current outputted from the drive element, and the terminal voltage of the organic light-emitting element connected with the drive element is controlled so that the lifetime of the organic light-emitting element can be extended.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for displaying an image, the system comprising a plurality of pixel structures, each of the pixel structures comprising:
an organic light-emitting element; and
a pixel driving circuit, which drives the organic light-emitting element, is electrically connected with a first scan line and a data line, wherein the pixel driving circuit comprises:
a drive element outputting a current to the organic light-emitting element,
a storage capacitor including a first terminal and a second terminal respectively electrically connected with two terminals of the drive element to control the current outputted from the drive element,
a select switch electrically connected with the first scan line to connect/disconnect the data line and the first terminal of the storage capacitor, and
a data switch electrically connected with the first scan line to connect/disconnect a second scan line and the second terminal of the storage capacitor.

2. The system according to claim 1, wherein the second scan line is a previous scan line adjacent to the first scan line.

3. The system according to claim 1, wherein the second scan line is a next scan line adjacent to the first scan line.

4. The system according to claim 1,
wherein the select switch and the data switch are transistors;
wherein the select switch comprises a gate electrically connected with the first scan line, a drain electrically connected with the data line and a source electrically connected with the first terminal of the storage capacitor; and
wherein the data switch has a gate electrically connected with the first scan line, a drain electrically connected with the second terminal of the storage capacitor and a source electrically connected with the second scan line.

5. The system according to claim 1, wherein the drive element is a transistor having a gate electrically connected with the first terminal of the storage capacitor, a source electrically connected with the second terminal of the storage capacitor and a drain electrically connected with a power source.

6. The system according to claim 1, wherein the pixel driving circuit further comprises:
a power switch electrically connected with the first scan line to connect/disconnect a power source and the drive element.

7. The system according to claim 6, wherein the power switch is a transistor having a gate electrically connected with the first scan line, a drain electrically connected with the power source and a source electrically connected with the drive element.

8. The system according to claim 6, wherein the drive element is an N-type transistor and the power switch is a P-type transistor.

9. The system according to claim 1, wherein the select switch, the data switch and the drive element are N-type transistors.

10. The system according to claim 1, wherein the pixel structures are arranged in an array.

11. The system according to claim 1, further comprising:
a scan driving circuit electrically connected with the first and second scan lines; and
a data driving circuit electrically connected with the data lines, wherein the pixel structures, the scan driving circuit and the data driving circuit constitute an organic light-emitting panel.

12. The system according to claim 11, further comprising:
an electronic device including the organic light-emitting panel and an input unit, the input unit being coupled with the organic light-emitting panel and providing an input to the organic light-emitting panel to make the organic light-emitting panel display the image.

13. The system according to claim 12, wherein the electronic device is a mobile phone, a digital camera, a personal digital assistant, a notebook computer, a desktop computer, a television, a vehicle display or a portable DVD drive.

14. A driving method being used in a pixel driving circuit, which drives an organic light-emitting element, is electrically connected with a first scan line and a data line, and comprises a drive element and a storage capacitor, the method comprising the steps of:
controlling a data signal to be written into the storage capacitor from the data line when a signal on the first scan line is enabled, so as to set a voltage at a first terminal of the storage capacitor;
controlling a second scan line to set a voltage at a second terminal of the storage capacitor when the signal on the first scan line is enabled; and
controlling the drive element to output a current to the organic light-emitting element according to a voltage difference between the first terminal and the second terminal of the storage capacitor to drive the organic light-emitting element to emit light.

15. The method according to claim 14, wherein a signal on the second scan line is disabled when the signal on the first scan line is enabled.

16. The method according to claim 14, wherein the second scan line is a previous scan line adjacent to the first scan line.

17. The method according to claim 14, wherein the second scan line is a next scan line adjacent to the first scan line.

18. The method according to claim 14, further comprising the steps of:
isolating a power source from the drive element when the first scan line is enabled; and
connecting the power source with the drive element when the first scan line is disabled.
